(19) United States
(12) Patent Application Publication
(10) Pub. No.: US 2009/0225232 A1
(43) Pub. Date: Sep. 10, 2009

(54) Mirror Arrangement for Image Rotation

(76) Inventors: Matthew Robert Lamb, Westfield, IN (US); Mark Alan Schultz, Carmel, IN (US)

Correspondence Address: Thomson Licensing LLC, P.O. Box 5312, Two Independence Way, PRINCETON, NJ, 08543-5312, US

(21) Appl. No.: 12/084,832

(22) PCT Filed: Nov. 8, 2006
(86) PCT No.: PCT/US2006/043415

§ 371 Date: May 4, 2009

Related U.S. Application Data
(60) Provisional application No. 60/734,865, filed on Nov. 9, 2005.

(51) Int. Cl. H04N 9/31

(52) U.S. Cl. 348/744; 348/E09.025

(57) ABSTRACT

A mirror arrangement consisting of two or more mirrors that are positioned to rotate an image in a projection system is described. The two or more mirrors can be any size to accommodate any size image that may be needed. An image beam produced by the projector or any other light source impinges on a first mirror positioned at an angle with respect thereto. This image beam is reflected towards a second mirror positioned at an angle with respect to the first mirror and reflected to a screen or other display source. The end result is that the projected image is rotated with respect to the source projector image in an efficient and inexpensive way.

### TECHNICAL FIELD

This invention relates to a technique for rotating an image in a projection system.

### BACKGROUND ART

In some rear-projection devices that make use of digital light projection, a problem can arise regarding the need to rotate each image in the system by 90 degrees. In some systems that combine multiple projectors (e.g., four projectors) into one, the images needed to be displayed in a way that was not intended by the projector manufacturer. Thus, the 16×9 horizontal image that would normally be displayed horizontally, would need to be turned on its side in a vertical 16×9 fashion. This can be accomplished optically, for example, using a roof prism or some other device, using mirrors, or physically rotating the projector in a way that it was not intended to operate.

In the past, the image rotation problem has been solved by physically mounting the projector in a rotated position. The problem with this is that many projectors will not operate reliably in a rotated position and this mounting arrangement may require expensive and complicated mounting structures. Alternatively, using an “off the shelf” optical device such as, for example, a roof prism, can also prove unrealistic due to the high cost of these devices.

### BRIEF SUMMARY OF THE INVENTION

The present invention is a mirror arrangement consisting of two or more mirrors that are positioned to rotate an image in a projection system. The two or more mirrors can be any size to accommodate any size image that may be needed. An image beam produced by the projector or any other light source impinges on a first mirror positioned at an angle with respect thereto. This image beam is reflected towards a second mirror positioned at an angle with respect to the first mirror and reflected to a screen or other display source. The end result is that the projected image is rotated with respect to the source projector image in an efficient and inexpensive way.

In one exemplary embodiment two mirrors are used. The two mirrors are arranged at 45 degree angles and turned 90 degrees from each other. An image beam produced by the projector or any other light source impinges on a first mirror positioned at a 45-degree angle with respect to the projector. This image beam is reflected towards a second mirror positioned at a 45-degree angle with respect to the first mirror and rotated 90 degrees therefrom and directed towards a screen or other display source. The end result is that the projected image is rotated 90 degrees with respect to the source projector.

### BRIEF SUMMARY OF THE DRAWINGS

FIG. 1 is a front view of the optical arrangement of the present principles, as seen from behind the projection screen; and

FIG. 2 is a side view of the optical arrangement of the present principles.

### DETAILED DESCRIPTION

The present invention is a mirror arrangement consisting of two or more mirrors that are positioned to rotate an image in a projection system. The two or more mirrors can be any size to accommodate any size image that may be needed. An image beam produced by the projector or any other light source impinges on a first mirror positioned at an angle with respect thereto. This image beam is reflected towards a second mirror positioned at an angle with respect to the first mirror and reflected to a screen or other display source. The end result is that the projected image is rotated with respect to the source projector image in an efficient and inexpensive way.

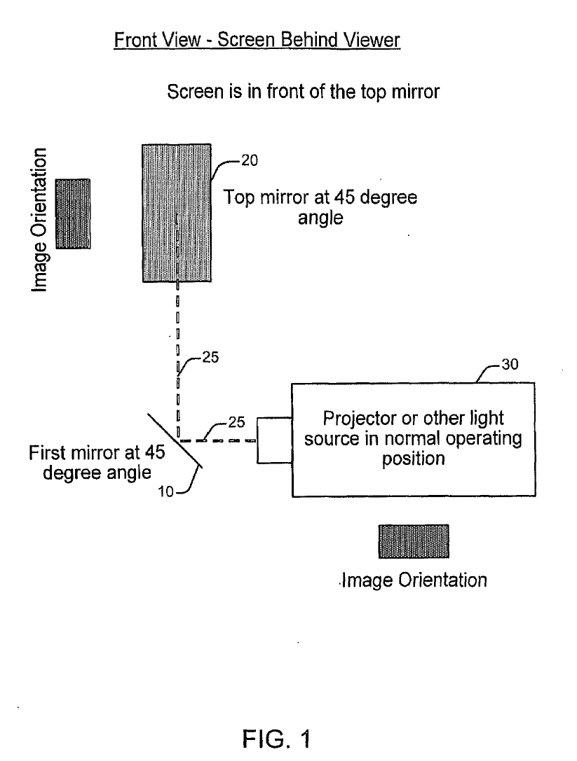

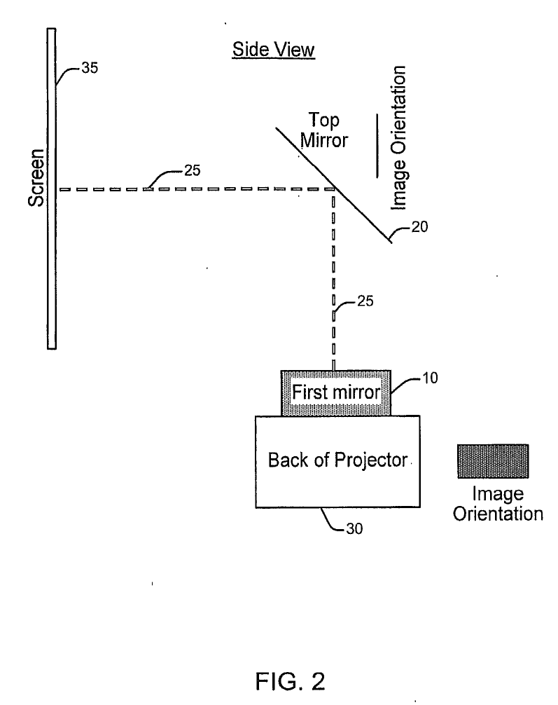

In one exemplary embodiment two mirrors 10, 20 are used as seen in FIGS. 1 and 2. The two mirrors 10, 20 are arranged at 45 degree angles and turned 90 degrees from each other. An image beam 25 produced by the projector 30 or any other light source impinges on a first mirror 10 positioned at a 45-degree angle with respect to the projector 30. This image beam 25 is reflected towards a second mirror 20 positioned at a 45-degree angle with respect to the first mirror 10 and rotated 90 degrees therefrom and directed towards a screen 35 or other display source. The end result is that the projected image is rotated 90 degrees with respect to the source projector.

The two or more mirrors may be positioned at angles between about 1 degree and about 90 degrees with respect to each other. The two or more mirrors may be rotated at angles between about 1 degree and about 90 degrees with respect to each other. The video information may be rotated between about 1 degree and about 90 degrees with respect to the source projector.

Preferably, the two or more mirrors are high quality optical grade first surface mirrors. The two or more mirrors may have the same size, or have different sizes. Additionally, the two or more mirrors may be positioned one above the other.

The mirrors may be mounted in an extruded aluminum frame that simply holds the glass mirror in an accurate and secure manner. Other methods of mounting and holding the glass could also be used.

The present invention may be used in the RLHEC system to additionally solve a potential thermal problem with the lamp position. Specifically, the present invention may also be useful in increasing the reliability of the RLHEC system. If a lamp burns out in a display system using the present invention, the glass falls to the bottom of the projector case. If a lamp burns out in a display system which does not use the present invention, shards of glass fall down into the fan motor of the projector, which may destroy the fan over time.

Although an exemplary mirror arrangement for a projection system which incorporates the teachings of the present invention has been shown and described in detail herein, those skilled in the art can readily devise many other varied embodiments that still incorporate these teachings.

1. A projection system, comprising:
a projector that provides video information;
two or more mirrors that rotate the video information provided by the projector; and
a screen that displays the rotated video information.

2. The projection system of claim 1 wherein the two or more mirrors are positioned at angles between about 1 degree and about 90 degrees with respect to each other.

3. The projection system of claim 1 wherein the two or more mirrors are rotated at angles between about 1 degree and about 90 degrees with respect to each other.

4. The projection system of claim 1 wherein the video information is rotated between about 1 degree and about 90 degrees.

5. The projection system of claim 1 wherein the two or more mirrors have different sizes.

6. The projection system of claim 1 wherein the two or more mirrors have the same size.

7. The projection system of claim 2 wherein the two or more mirrors are positioned at an angle of about 45 degrees with respect to each other.

8. The projection system of claim 3 wherein the two or more mirrors are rotated at an angle of about 90 degrees with respect to each other.

9. The projection system of claim 4 wherein the video information is rotated by about 90 degrees.
